(19) United States
(12) Patent Application Publication
(10) Pub. No.: US 2022/0080929 A1
(43) Pub. Date: Mar. 17, 2022

(54) CLEANING SYSTEM FOR EQUIPMENT OF A MOTOR VEHICLE AND ASSOCIATED VEHICLE

(71) Applicant: VALEO SYSTEMES D'ESSUYAGE, La Verriere (FR)

(72) Inventors: Jose-Luis HERRADA, La Verriere (FR); Alexandre PASCHUTINE, La Verriere (FR)

(73) Assignee: VALEO SYSTEMES D'ESSUYAGE, La Verriere (FR)

(21) Appl. No.: 17/423,916

(22) PCT Filed: Jan. 7, 2020
(86) PCT No.: PCT/EP2020/050234

§ 371 Date: Jul. 19, 2021

(30) Foreign Application Priority Data
Jan. 22, 2019 (FR) 1900555

(51) Int. Cl. B60S 1/48; B60S 1/52; B60S 1/56

(52) U.S. Cl. CPC B60S 1/482; B60S 1/56; B60S 1/522

(57) ABSTRACT

The present invention relates to a cleaning system for equipment of a motor vehicle comprising at least one wiper element; a mechanism for driving the wiper element, comprising an electric motor; a device for spraying a cleaning liquid comprising a hydraulic pump and at least one spray nozzle, in which the spraying device comprises a hydraulic valve to allow the supply of liquid to the at least one spray nozzle, said hydraulic valve comprising a movable plunger to allow or prevent the passage of the cleaning liquid, said movable plunger being movably connected to a movable element of the drive mechanism so that the position of said plunger is selected by a movement of said movable element of the drive mechanism.

### CROSS-REFERENCE TO RELATED APPLICATIONS

This is a 371 application (submitted under 35 U.S.C. § 371) of International Application No. PCT/EP2020/050234 (WO2020/151941) filed on Jan. 7, 2020, which claims the priority date benefit of French Application No. FR1900555 filed on Jan. 22, 2019, the disclosures of which are hereby incorporated by reference in their entirety.

### TECHNICAL FIELD

The present invention relates to the field of cleaning systems for equipment of motor vehicles.

### BACKGROUND

Present-day motor vehicles increasingly use sensors to assist the driver and make vehicles increasingly autonomous. In particular, a number of optical devices are used to analyze the environment of the vehicle, detect obstacles or measure distances. These optical devices are for example cameras or light detection and ranging (LIDAR) devices.

To allow the satisfactory operation of these different optical detection devices, the presence of obstructing elements such as dirt in the field of the optical detection device must be prevented. To this end, it is known practice to use cleaning devices that make it possible to spray liquid onto a protective screen of the optical detection device. These cleaning devices comprise a hydraulic pump so that the cleaning liquid can be conveyed from a tank to a spray nozzle situated in line with the optical detection device. In order to limit the number of hydraulic pumps and the consumption of cleaning liquid, it is known practice to use solenoid valves to prevent or permit the passage of the cleaning liquid to a spray nozzle when there are several spray nozzles to be supplied independently, that is, at different times. A solenoid valve is a hydraulic valve that comprises a command portion comprising a solenoid the supply of power to which makes it possible to select an open or closed position of the valve.

However, the multiplicity of solenoid valves also results in additional weight and not inconsiderable additional cost, as well as a large footprint due to the magnetic command portion, particularly when the number of optical detection devices to be cleaned increases.

### SUMMARY

A solution must therefore be found that makes it possible to further reduce the weight and cost of a cleaning device comprising a plurality of spray nozzles that must be supplied independently.

To this end, the present invention relates to a cleaning system for equipment of a motor vehicle comprising:

at least one wiper element,

a mechanism for driving the wiper element comprising an electric motor,

a device for spraying a cleaning liquid comprising a hydraulic pump and at least one spray nozzle,

in which the spraying device comprises a hydraulic valve to allow the supply of liquid to the at least one spray nozzle, said hydraulic valve comprising a movable plunger to allow or prevent the passage of the cleaning liquid, said movable plunger being movably connected to a movable element of the drive mechanism so that the position of said plunger is selected by a movement of said movable element of the drive mechanism.

According to another aspect of the present invention, the movable element of the drive mechanism is configured to be moved in a predetermined sector between a first position and a second position when the wiper element is driven and in which said movable element comprises a cam configured to change the position of the plunger of the hydraulic valve in certain positions of the movable element in the predetermined sector.

According to another aspect of the present invention, the drive mechanism comprises a reversible motor and a cam configured to change the position of the plunger of the hydraulic valve when the direction of rotation of the electric motor changes.

According to another aspect of the present invention, the movable element of the drive mechanism is configured to be moved in a predetermined sector between a first position and a second position when the wiper element is driven and to be moved to a third position outside the predetermined sector in order to change the position of the plunger of the hydraulic valve.

According to another aspect of the present invention, the third position corresponds to an over-travel of the movable element of the drive mechanism obtained by commanding the electric motor.

According to another aspect of the present invention, the movable element of the drive mechanism is configured to be moved to a fourth position, outside the predetermined sector and opposite the third position, in order to change the position of the plunger of the hydraulic valve in an opposite direction to the change obtained by the third position.

According to another aspect of the present invention, the plunger is configured to move between a stop position in which the hydraulic valve prevents the passage of the cleaning liquid to the at least one spray nozzle and an open position in which the hydraulic valve permits the passage of the cleaning liquid to the at least one spray nozzle.

According to another aspect of the present invention, the hydraulic valve comprises elastic means for returning the plunger to the stop position so that when the hydraulic valve passes from the stop position to the open position, a predetermined quantity of cleaning liquid is delivered to the spray nozzle.

According to another aspect of the present invention, the system comprises a first spray nozzle associated with a first item of equipment and a second spray nozzle associated with a second item of equipment and in which the plunger is configured to move between a first position in which the hydraulic valve prevents the passage of the cleaning liquid to the first spray nozzle and permits the passage of the cleaning liquid to the second spray nozzle and a second position in which the hydraulic valve permits the passage of the cleaning liquid to the first spray nozzle and prevents the passage of the cleaning liquid to the second spray nozzle.

According to another aspect of the present invention, the first spray nozzle is associated with the windscreen of the vehicle and the second spray nozzle is associated with an optical detection device of the motor vehicle.

According to another aspect of the present invention, the at least one wiper element is a wiper blade of a windscreen of the motor vehicle and the drive mechanism corresponds to the linkage associated with said at least one wiper element.

According to another aspect of the present invention, the at least one wiper element is a wiper blade of a protective screen of an optical device of the motor vehicle.

According to another aspect of the present invention, the system also comprises a selector coupled to the hydraulic valve, said selector comprising an inlet configured to be in fluid communication with the hydraulic valve and a plurality of outlets configured to be in fluid communication with respective spray nozzles, said selector being configured to place one of the outlets in fluid communication with its inlet and comprising a movable selection switch movably connected to a movable element of the drive mechanism so that the position of said switch can be selected by a movement of said movable element of the drive mechanism.

According to another aspect of the present invention, the hydraulic valve is a combined valve also configured to be connected to a compressed air supply device and in which the plunger is configured to allow or prevent the passage of the compressed air.

The present invention also relates to a motor vehicle comprising a cleaning system as described above.

### BRIEF DESCRIPTION OF THE DRAWINGS

Further features and advantages of the invention will become more clearly apparent upon reading the following description, which is given by way of illustrative and non-limiting example, and the appended drawings, in which:

FIG. 1 shows a motor vehicle cleaning system according to a first embodiment of the present invention;

FIG. 2 shows a hydraulic valve of the cleaning system in a first position;

FIG. 3 shows a hydraulic valve of the cleaning system in a second position;

FIG. 4 shows a drive wheel comprising an asymmetrical cam according to a first embodiment;

FIG. 5 shows a drive wheel comprising an asymmetrical cam according to a second embodiment;

FIG. 6 shows a drive wheel according to a third embodiment; [FIG. 7] shows a drive wheel according to a fourth embodiment;

FIG. 8 shows a motor vehicle cleaning system according to a second embodiment in a first position;

FIG. 9 shows a motor vehicle cleaning system according to the second embodiment in a second position;

FIG. 10 shows a motor vehicle cleaning system according to the second embodiment in a third position;

FIG. 11 shows a motor vehicle cleaning system according to a variant of the second embodiment;

FIG. 12 shows a motor vehicle cleaning system according to a third embodiment;

FIG. 13 shows a three-way hydraulic valve in a first position;

FIG. 14 shows a three-way hydraulic valve in a second position.

In these figures, identical elements have the same reference signs.

### DETAILED DESCRIPTION

The following embodiments are examples. Although the description refers to one or more embodiments, this does not necessarily mean that each reference sign relates to the same embodiment, or that the features only apply to just one embodiment. Individual features of different embodiments can also be combined or interchanged in order to create other embodiments.

The present invention relates to a cleaning system comprising at least one wiper element such as a wiper blade and a mechanism for driving the wiper element such as a linkage. The drive mechanism also comprises an electric motor and is configured to drive the wiper element, particularly in an alternating back-and-forth movement.

The cleaning system can comprise the windscreen wiper device associated with the windscreen of the vehicle (front or rear windscreen) but can also comprise a wiper device of another element of the vehicle such as an optical detection element such as a camera.

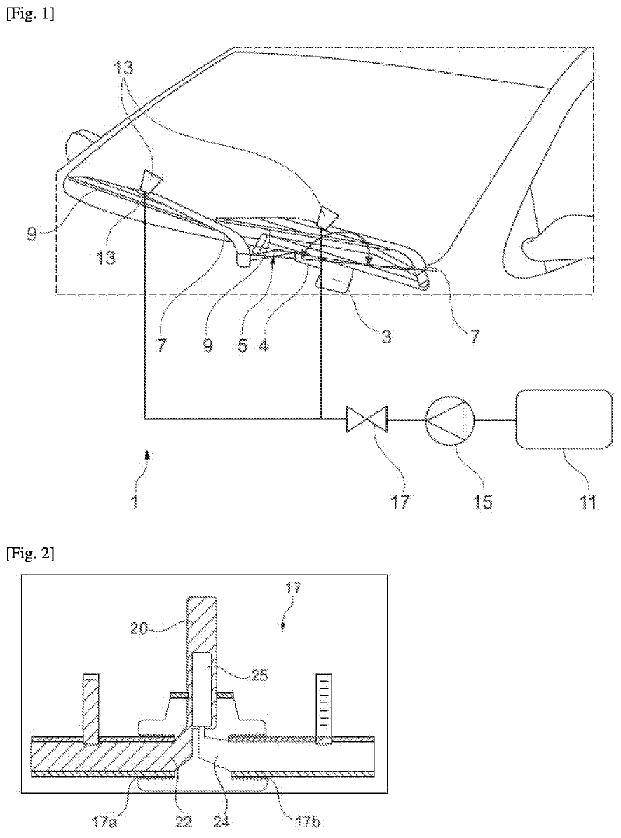

FIG. 1 shows an example of a cleaning system 1 comprising a front windscreen wiper device.

The cleaning system 1 comprises a drive mechanism 5 comprising for example a geared motor 3 and a linkage that makes it possible to convert the rotating movement of the output shaft of the geared motor 3 into a back-and-forth movement of the wiper arms 7 holding the wiper blades 9, two in number in this case.

The geared motor 3 comprises an electric motor, for example a brushed or brushless DC reversible electric motor 4 and a mechanical reduction gear the reduction ratio of which is for example 1:69.

The cleaning system 1 also comprises a device for spraying a cleaning liquid comprising a cleaning liquid tank 11, one or more spray nozzles 13 in fluid connection with the liquid tank 11 and a hydraulic pump 15 configured to supply the spray nozzles 13 with cleaning liquid. The hydraulic pump 15 is for example activated when the cleaning system is activated. The spraying device also comprises a hydraulic valve 17 arranged between the hydraulic pump 15 and the spray nozzles 13.

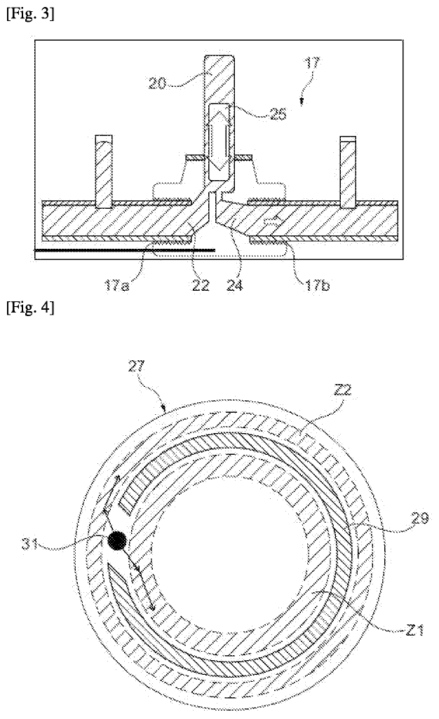

FIGS. 2 and 3 show a diagram of an exemplary embodiment of a hydraulic valve 17. The hydraulic valve 17 comprises a transfer chamber 20 in fluid connection with an inlet port 17a via a first channel 22 and with an outlet port 17b via a second channel 24.

The transfer chamber 20 comprises a plunger 25 that can move in translation in the transfer chamber 20 between a stop position in which the plunger obstructs the fluid passage between the first channel 22 and the second channel 24 so that a fluid cannot be transferred from the inlet port 17a to the outlet port 17b as shown in FIG. 2 and an open position in which the plunger 25 leaves the fluid passage between the first channel 22 and the second channel 24 free so as to allow the passage of a fluid between the inlet port 17a and the outlet port 17b as shown in FIG. 3. The inlet port 17a is configured to be in fluid connection with the hydraulic pump 15. The outlet port 17b is configured to be in fluid connection with the spray nozzles 13.

In addition, the plunger 25 is movably connected to a movable element of the drive mechanism 5 so that the position of the plunger 25 can be selected by the movement of the movable element and therefore by commanding the electric motor 4 of the geared motor 3.

Various embodiments make it possible to produce the movable connection between the plunger 25 and a movable element of the drive mechanism 5.

According to a first embodiment, the electric motor 4 is configured to rotate in the same direction at all times (one or other of the two possible directions of rotation) when the wiper element(s) 9 is/are driven and the drive mechanism 5 is configured to convert the rotation of the electric motor 4 in the chosen direction into an alternating back-and-forth movement of the wiper element 9. In this case, the movable element of the drive mechanism 5 is for example formed by a cam wheel 27 (visible in FIG. 4) that is rotatably coupled to the output shaft of the geared motor 3. The cam wheel 27 is configured to move the plunger 25 to its stop position when the cam wheel 27 rotates in a first direction, for example clockwise, and to move the plunger 25 to its open position when the cam wheel 27 rotates in the opposite direction.

FIG. 4 shows an exemplary embodiment of the cam wheel 27. The cam wheel 27 comprises a cam 29 with a generally circular shape that defines a central zone Z1 and a peripheral zone Z2. The cam 29 comprises at least one radial opening the edges of which have an asymmetrical beveled shape so that they drive a stud 31 towards the peripheral zone Z2 or towards the central zone Z1 depending on the direction of rotation of the cam wheel 27. The stud 31 can be configured to be in a radial position corresponding to the cam 29 in a rest position.

The stud 31 can be rigidly connected to the plunger 25 so that the radial position of the plunger 31 relative to the cam wheel 27 makes it possible to control the opening or closing of the hydraulic valve 17.

When the electric motor 4 drives the cam wheel 27 in a clockwise direction of rotation, the stud 31 is thus driven towards the central zone Z1 corresponding for example to the stop position of the plunger 25 and when the electric motor 4 drives the cam wheel 27 in the opposite direction of rotation, the stud 31 is driven towards the peripheral zone Z2 corresponding for example to the open position of the plunger 25. It is thus sufficient to command the electric motor 4 to rotate in the direction corresponding to the desired position of the plunger 25 in order to control the opening or closing of the hydraulic valve 17.

The invention is not limited to the embodiment in FIG. 4, but extends to all embodiments comprising an asymmetrical part that makes it possible to change the position of the plunger 25 depending on the direction of rotation of the electric motor 4.

According to one variant embodiment, when the wiper element(s) 9 is/are driven, the electric motor 4 is configured to rotate in a first direction to a predetermined first position of the wiper element(s) 9, for example the vertical position in FIG. 1, and, when the first position is reached, to rotate in the second direction, opposite to the first, to a predetermined second position of the wiper element(s) 9, for example the horizontal position in FIG. 1. When the second position is reached, the electric motor 4 rotates again in the first direction of rotation to the predetermined first position, and so on. The angular amplitude between the predetermined first position and the predetermined second position is for example between 100 and 160 degrees.

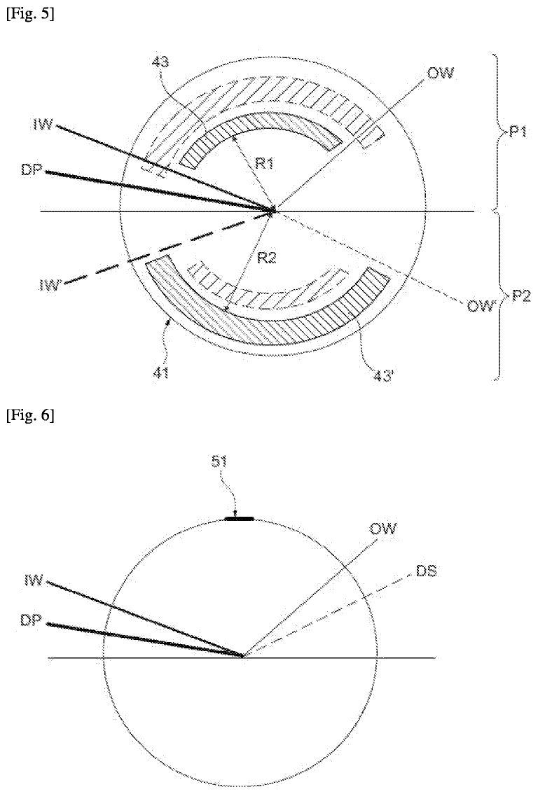

FIG. 5 shows a wheel 41 for driving the wiper element(s) 9 on which the predetermined first and second positions IW and OW are shown. The drive wheel 41 also comprises a rest position DP corresponding to the position adopted when wiping is stopped. These different positions are situated in a first portion P1 of the drive wheel corresponding to a semi-circle (or half-disk). It is then possible to define these different positions on a second portion P2 of the drive wheel 41, that is, on the opposite semi-circle. Predetermined third and fourth positions IW′ and OW′ are shown in FIG. 5; these third and fourth positions IW′ and OW′ are symmetrical with the first and second positions IW and OW relative to the diameter of the drive wheel 41 separating the portions P1 and P2. In addition, the drive wheel 41 comprises a first cam 43 situated in the first portion P1 comprising the first and second positions IW and OW and a second cam 43′ situated in the second portion P2 comprising the third and fourth positions IW′ and OW′. The first cam 43 extends along a first radius R1 and the second cam 43′ extends along a second radius R2 different from the first radius R1 so that the use of the first portion P1 of the drive wheel 41 causes, for example, the movement of the plunger 25 to the stop position and the use of the second portion P2 of the drive wheel 41 causes, for example, the movement of the plunger 25 to the open position. By commanding the electric motor 4 so that the first portion P1 of the drive wheel 41 or the second portion P2 of the drive wheel 41 is used, it is thus possible to select whether to open the hydraulic valve 25 and therefore spray cleaning liquid or to close the hydraulic valve 17 and not spray cleaning liquid.

According to another variant embodiment, it is also possible to determine one or more additional positions of a drive wheel corresponding to a change in position of the plunger 25 of the hydraulic valve 17.

FIG. 6 shows an example of a drive wheel 51 comprising predetermined first and second positions IW and OW together with a rest position DP corresponding to the position adopted when wiping is stopped. It is then possible to define an additional predetermined position denoted DS situated outside the angular sector situated between IW and OW and corresponding to a position associated with a change in position of the plunger 25 of the hydraulic valve 17 so that it passes from a stop position to an open position or vice versa when the position DS is reached. The additional predetermined position DS corresponds for example to an over-travel beyond the predetermined positions IW and OW. Thus, by commanding the electric motor 4 to place the drive wheel 51 in the position DS, it is possible to command the opening or closing of the hydraulic valve and therefore the spraying or not spraying of cleaning liquid.

The hydraulic valve 17 can also comprise a number of positions greater than two and commanding the movable element to the additional position DS results in the hydraulic calve 17 passing to the next position. The different positions of the hydraulic valve correspond for example to positions for supplying different spray nozzles 13.

Alternatively, it is possible to define a first additional position DS1 associated with the movement of the plunger 25 from the stop position to the open position and an additional second position DS2 associated with the movement of the plunger 25 from the open position to the stop position as shown in FIG. 7.

If the hydraulic valve 17 comprises a number of positions greater than two, several additional positions DS1, DS1′, DS1″ can be defined in order to select the desired position of the hydraulic valve 17.

According to an alternative embodiment, not shown, the electric motor 4 is a continuous (non-reversible) motor and the drive mechanism 5 comprises a linkage for converting the rotating movement of the electric motor 4 into an alternating movement of the wiper arms 7 and in which the movable element 41 (corresponding substantially to the drive wheel 41 in FIG. 5 the portion P2 of which would not comprise a cam 43′ and the cam 43 of which would extend over a smaller portion of the sector IW-OW) is a wheel for driving the wiper arms 7 configured to be rotated between a first position IW and a second position OW defining a predetermined sector. The drive wheel 41 comprises a cam 43 configured to move the plunger 25 when the drive wheel is in certain positions inside the predetermined sector. For example, the cam can be configured to move the plunger 25 to an open position of the hydraulic valve 17 when the wiper arms 7 move in a first direction and to move the plunger 25 to a closed position of the hydraulic valve 17 when the wiper arms 7 move in a second direction opposite to the first direction. In this embodiment, spraying takes place when the wiper element is in certain predetermined positions between the two extreme wiping positions IW and OW and optionally depending on the direction of movement of the wiper arms 7 to allow, for example, spraying only during movement from the first position IW to the second position OW or conversely only from the second position OW to the first position IW, which makes it possible to spray only when the wiper arm is moving in a certain direction (and optionally only in certain positions in this direction).

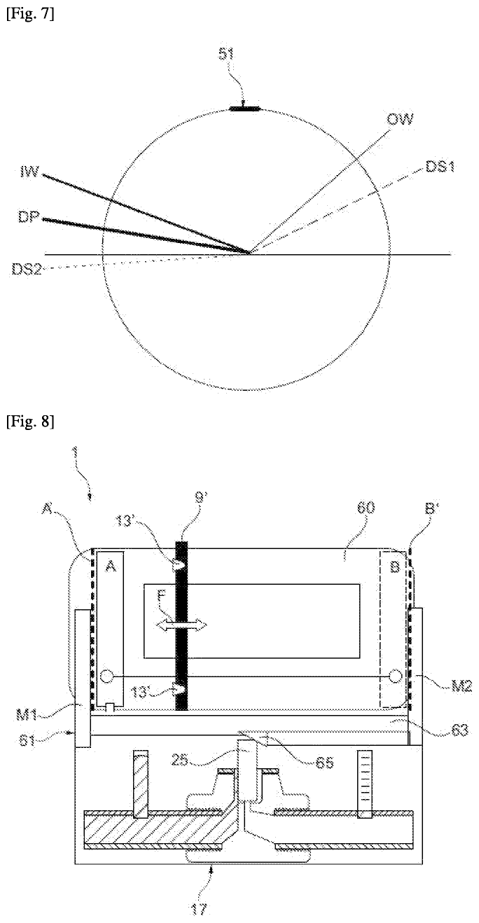

FIGS. 8 to 10 show a diagram of a second embodiment of a cleaning system 1 in which the plunger 25 of the hydraulic valve 17 is commanded based on the use of two additional positions. The cleaning system 1 is for example associated with a protective screen 60 of a camera.

In this embodiment, the wiper element 9′ is configured to be moved laterally against the protective screen 60, between a first position A situated on a first side of the protective screen 60 and a second position B situated on a second side, opposite the first side, of the protective screen 60. The movement is represented by the arrow F. When wiping is activated, the wiper element 9 is thus translated between positions A and B.

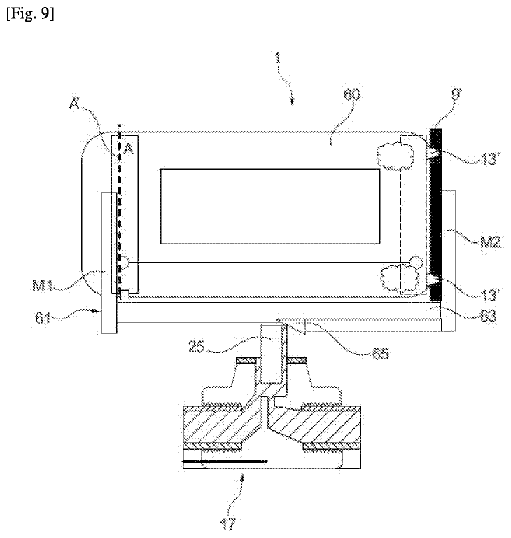

The cleaning system 1 also comprises a support 61 that can be moved laterally and comprises a horizontal base 63 comprising a cam 65 configured to come into contact with the plunger 25 of the hydraulic valve 17 and two uprights M1 and M2 configured to be placed on either side of the protective screen 60, outside the sector situated between positions A and B. The uprights M1 and M2 are arranged in the same plane as the wiper element so that the wiper element 9′ can come into contact with the uprights M1 and M2 in the event of movement beyond positions A and B. The cleaning system 1 also comprises an electric motor and a drive mechanism (not shown) configured to move the wiper element 9′, and a spraying device similar to the first embodiment. The spray nozzles 13′ are for example situated in line with the wiper element 9′. Thus, by defining an additional position B′ situated beyond position B and by commanding the electric motor for driving the wiper element 9′ to move the wiper element 9′ to position B′ so that the wiper element 9′ comes into contact with the upright M2 and causes the movement of the support 61 to the right. This movement of the support 61 and therefore of the cam 65 makes it possible to make the plunger 25 pass from the stop position of the hydraulic valve 17 to the open position of the hydraulic valve 17 as shown in FIG. 9. The hydraulic valve 17 then lets the cleaning liquid pass to the spray nozzles 13′, which results in the cleaning liquid being sprayed onto the protective screen 60.

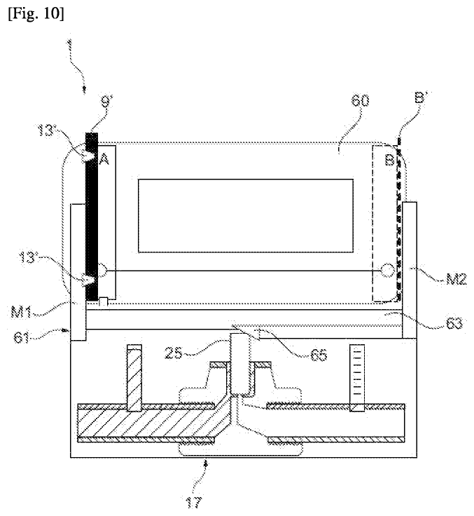

Likewise, by defining an additional predetermined position A′ situated beyond position A and by commanding the electric motor 4 for driving the wiper element 9′ to move the wiper element 9′ to position A′ so that the wiper element 9′ comes into contact with the upright M1 and causes the movement of the support 61 to the left. This movement of the support 61 and therefore of the cam 65 makes it possible to make the plunger 25 pass from the open position of the hydraulic valve 17 to the stop position of the hydraulic valve 17 as shown in FIG. 10. The hydraulic valve 17 then prevents the cleaning liquid from passing through to the spray nozzles 13′. The additional predetermined position A′ corresponds for example to an over-travel beyond the predetermined position A.

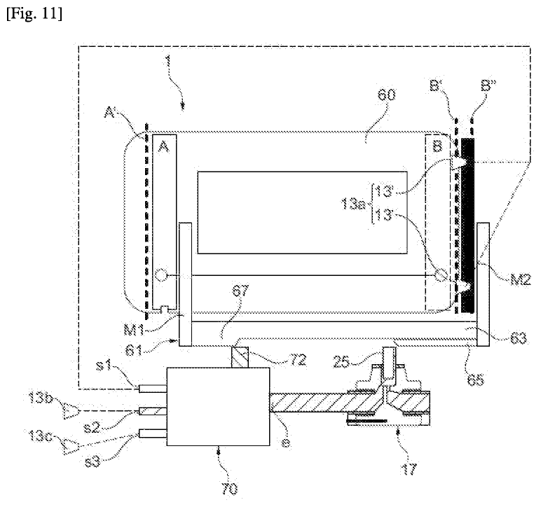

According to an additional embodiment shown in FIG. 11, the cleaning system 1′ differs from the embodiment in FIGS. 8 to 10 through the presence of at least one first spray nozzle 13a associated with a first item of equipment of the motor vehicle and at least one second spray nozzle 13b associated with a second item of equipment of the motor vehicle, and through the use of a selector 70 coupled to the outlet of the hydraulic valve 17 and configured to select the spray nozzle(s) 13a, 13b to be supplied.

In this case, the selector 70 comprises an inlet e in fluid connection with the hydraulic valve 17, a first outlet s1 in fluid connection with a first spray nozzle 13a corresponding for example to the spray nozzles 13′ associated with the protective screen 60, a second outlet s2 in fluid connection for example with a second spray nozzle 13b associated with a camera, particularly a reversing or parking assistance camera, and a third outlet s3 in fluid connection for example with a third spray nozzle 13c associated with an item of light detection and ranging (LIDAR) equipment. The selector 70 is configured to place one of the outlets s1, s2 or s3 in fluid communication with the inlet e.

In addition, the selector 70 comprises a movable switch 72 that makes it possible to select the outlet s1, s2 or s3 placed in fluid connection with the inlet e, said switch 72 being movably connected to a movable element of the drive mechanism so that the position of the switch 72 can be selected by commanding the electric motor 4 of the drive mechanism 5 in the same way as for the plunger 25 of the hydraulic valve 17. The selector 70 is commanded for example by defining a position B″ beyond position B′ and by using a second cam 67 of the support 61 that moves the switch 72 when the wiper element 9′ is moved to position B″ and drives the support 61 and therefore the second cam 67. The movement of the switch 72 by the second cam 67 places another outlet s1, s2 or s3 in fluid communication with the inlet e. The use of a selector 70 thus makes it possible to command the spraying of cleaning liquid for a plurality of items of equipment by commanding the electric motor 4 without requiring solenoid valves or another electromechanical device.

Such a selector 70 can also be controlled using a drive wheel as described above, comprising cams and additional predetermined positions associated with commanding the selector 70.

In addition, it must be noted that for all of the embodiments set out above, the hydraulic valve 17 can comprise elastic means, such as a spring, for returning the plunger 25 to the stop position so that when the hydraulic valve 17 passes from the stop position to the open position, the elastic return means return the plunger to the stop position of the hydraulic valve after a predetermined time, for example two seconds, so that a predetermined quantity of cleaning liquid is delivered to the spray nozzles 13.

Furthermore, the hydraulic valve 17, 17′ can also be a combined valve configured to be connected to a compressed air supply device, for example a compressor. The combined valve comprises for example a second inlet connected to the compressed air supply device. The plunger 25 is for example configured to adopt three positions. A first position in which it prevents the passage of the cleaning liquid and compressed air to the spray nozzle, a second position in which it permits the passage of the cleaning liquid and prevents the passage of the compressed air to the spray nozzle and a third position in which it prevents the passage of the cleaning liquid and permits the passage of the compressed air. The second and third positions of the plunger 25 correspond for example to a first and second additional position of the movable element. The electric motor can thus be controlled so that the combined valve permits the spraying of cleaning liquid for a predetermined time, for example three seconds, or in a predetermined position of the wiper element, for example when the wiper element is moved in a first direction, then to permit the transfer of compressed air for a predetermined time, for example five seconds, or in a predetermined position of the wiper element, for example when the wiper element is moved in a second direction.

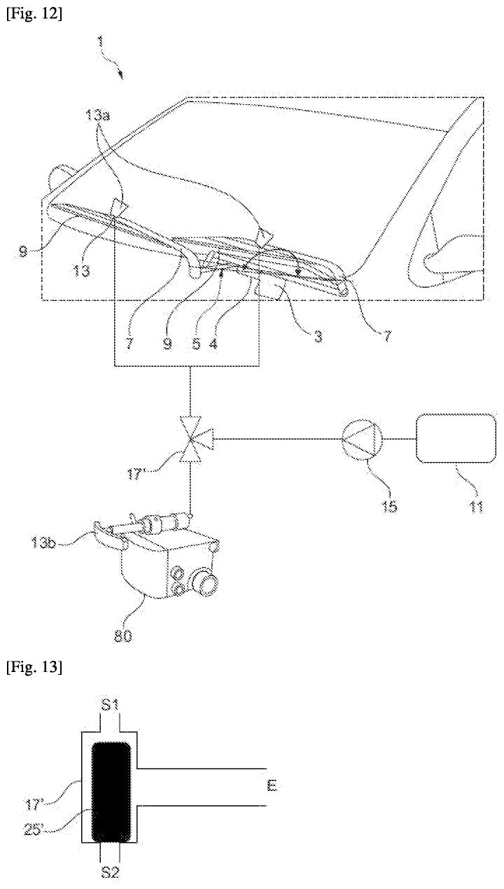

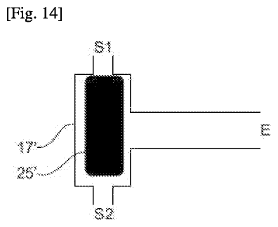

According to another embodiment shown in FIG. 12, the cleaning system 1 differs from the embodiment in FIG. 1 through the presence of at least one first spray nozzle 13a, two in this case, associated with a first item of equipment of the motor vehicle, for example the windscreen of the motor vehicle, and at least one second spray nozzle 13b associated with a second item of equipment of the motor vehicle, for example a camera or an item of light detection and ranging (LIDAR) equipment 80, and through the use of a three-way hydraulic valve 17′. FIGS. 13 and 14 show a three-way hydraulic valve 17′ that comprises an inlet E configured to be in fluid connection with the hydraulic pump 15, a first outlet S1 configured to be in fluid connection with the first spray nozzles 13a and a second outlet S2 configured to be in fluid connection with the second spray nozzle 13b. In addition, the hydraulic valve 17′ comprises a plunger 25′ configured to move between a first position shown in FIG. 13 in which it lets the cleaning fluid pass between the inlet E and the first outlet S1 of the hydraulic valve 17′ while preventing the passage of the cleaning fluid between the inlet E and the second outlet S2 of the hydraulic valve 17′ and a second position shown in FIG. 14 in which it lets the cleaning fluid pass between the inlet E and the second outlet S2 of the hydraulic valve 17′ while preventing the passage of the cleaning fluid between the inlet E and the first outlet S1 of the hydraulic valve 17′. In addition, as for the preceding embodiments, the plunger 25′ is movably connected to a movable element of the drive mechanism 5 so that the position of the plunger 25′ can be selected by commanding the electric motor 4 of the drive mechanism 5. The connection between the plunger 25′ and the movable element of the drive mechanism 5 can be similar to the connections disclosed in the preceding embodiments.

The present invention also relates to a vehicle comprising a plurality of items of equipment requiring the spraying of cleaning liquid and a cleaning system 1 according to one of the embodiments described above. The cleaning system can comprise a plurality of hydraulic or combined valves 17, 17′ and spray nozzles 13, 13′ as described above, and several hydraulic or combined valves 17, 17′ can be controlled by a single movable element.

The present invention thus makes it possible, by movably connecting the plunger of a hydraulic valve to a movable element of the drive mechanism of a cleaning system comprising wiper elements driven by an electric motor, to obtain a hydraulic valve the opening and closing of which can be commanded by commanding the electric drive motor of the cleaning system. This makes it possible to reduce the weight and cost of the hydraulic valves, which no longer comprise an electromagnetic portion and thus to reduce the overall cost of the cleaning system of the vehicle while enabling optimum control of the consumption of cleaning liquid.

What is claimed is:

1. A cleaning system for equipment of a motor vehicle comprising:
at least one wiper element,
a mechanism for driving the wiper element comprising an electric motor,
a device for spraying a cleaning liquid comprising a hydraulic pump and at least one spray nozzle,
characterized in that the spraying device comprises a hydraulic valve to allow the supply of liquid to the at least one spray nozzle, said hydraulic valve comprising a movable plunger to allow or prevent the passage of the cleaning liquid, said movable plunger being movably connected to a movable element of the drive mechanism so that the position of said plunger is selected by a movement of said movable element of the drive mechanism.

2. The system as claimed in claim 1, in which the movable element of the drive mechanism is configured to be moved in a predetermined sector between a first position and a second position when the wiper element is driven and in which said movable element comprises a cam configured to change the position of the plunger of the hydraulic valve in certain positions of the movable element in the predetermined sector.

3. The system as claimed in claim 1, in which the drive mechanism comprises a reversible motor and a cam configured to change the position of the plunger of the hydraulic valve when the direction of rotation of the electric motor changes.

4. The system as claimed in claim 1, in which the movable element of the drive mechanism is configured to be moved in a predetermined sector between a first position and a second position when the wiper element is driven and to be moved to a third position outside the predetermined sector in order to change the position of the plunger of the hydraulic valve

5. The system as claimed in claim 4, in which the third position corresponds to an over-travel of the movable element of the drive mechanism obtained by commanding the electric motor.

6. The system as claimed in claim 4, in which the movable element of the drive mechanism is configured to be moved to a fourth position, outside the predetermined sector and opposite the third position, in order to change the position of the plunger of the hydraulic valve in an opposite direction to the change obtained by the third position.

7. The system as claimed in claim 1, in which the plunger is configured to move between a stop position in which the hydraulic valve prevents the passage of the cleaning liquid to the at least one spray nozzle and an open position in which the hydraulic valve permits the passage of the cleaning liquid to the at least one spray nozzle.

8. The system as claimed in claim 7, in which the hydraulic valve comprises elastic means for returning the plunger to the stop position so that when the hydraulic valve passes from the stop position to the open position, a predetermined quantity of cleaning liquid is delivered to the spray nozzle.

9. The system as claimed in claim 1, comprising a first spray nozzle associated with a first item of equipment and a second spray nozzle associated with a second item of equipment and in which the plunger is configured to move between a first position in which the hydraulic valve prevents the passage of the cleaning liquid to the first spray nozzle and permits the passage of the cleaning liquid to the second spray nozzle and a second position in which the hydraulic valve permits the passage of the cleaning liquid to the first spray nozzle and prevents the passage of the cleaning liquid to the second spray nozzle.

10. The system as claimed in claim 9, in which the first spray nozzle is associated with the windscreen of the vehicle and the second spray nozzle is associated with an optical detection device of the motor vehicle.

11. The system as claimed in claim 1, in which the at least one wiper element is a wiper blade of a windscreen of the motor vehicle and the drive mechanism corresponds to the linkage associated with said at least one wiper blade.

12. The system as claimed in claim 1, in which the at least one wiper element is a wiper blade of a protective screen of an optical device of the motor vehicle.

13. The system as claimed in claim 1, further comprising a selector coupled to the hydraulic valve, said selector comprising an inlet configured to be in fluid communication with the hydraulic valve and a plurality of outlets configured to be in fluid communication with respective spray nozzles, said selector being configured to place one of the outlets in fluid communication with its inlet and comprising a movable selection switch movably connected to a movable element of the drive mechanism so that the position of said switch can be selected by a movement of said movable element of the drive mechanism.

14. The system as claimed in claim 1, in which the hydraulic valve is a combined valve also configured to be connected to a compressed air supply device and in which the plunger is configured to allow or prevent the passage of the compressed air.

15. A motor vehicle comprising a cleaning system according to claim 1.
